(19) United States
(12) Patent Application Publication
(10) Pub. No.: US 2011/0233119 A1
(43) Pub. Date: Sep. 29, 2011

(54) SPORTS BOTTLE DEVICE WITH FILTER ISOLATED FROM FILTERED FLUID

(76) Inventor: Steven D. Nelson, Buena Park, CA (US)

(21) Appl. No.: 12/913,746

(22) Filed: Oct. 27, 2010

Related U.S. Application Data
(63) Continuation-in-part of application No. 12/749,245, filed on Mar. 29, 2010.

(51) Int. Cl. B01D 35/02; C02F 1/00; B65D 1/04

(52) U.S. Cl. 210/117

(57) ABSTRACT

A sports bottle device including a pair of compartments forming filtered and unfiltered chambers, a filter in the unfiltered chamber, an isolation device isolating the filter from the filtered chamber and a piston pump for pumping fluid to the filtered chamber.

### CROSS-REFERENCES TO RELATED APPLICATIONS

This application is a Continuation-in-Part Application based upon and claims domestic priority from U.S. non-provisional application Ser. No. 12/749,245, filed Mar. 29, 2010, now U.S. Pat. No. ______; the entire contents of which are incorporated herein by reference.

### BACKGROUND OF THE INVENTION

1. Field of the Invention

The field of the invention relates to sports bottles and particularly to sports bottles incorporating filters for filtering tap water and the like.

2. Description of the Prior Art

With the active healthy way of life subscribed to by many in society, a great demand exists for personal sports bottles for carrying a quantity of refreshing or energizing liquid for quick hydration during sporting activities such as running, bicycling, hiking, tennis, golf and the like. Typically, sports bottles are constructed of plastic, a material often not biodegradable and, with the relatively high consumption at today's rates, the landfills are fast filling with single use bottles.

It has long been recognized that the cost and inconvenience of accessing filtered water is a problem which can discourage consumption of sufficient quantities of fluids to adequately hydrate the athlete. Accordingly, there has long existed a need for a compact and convenient filtration device which would allow for use of readily available tap water to be conveniently and inexpensively introduced and filtered allowing for numerous repeated fills and a long service life.

The need for water purification was recognized long ago by inventors seeking to provide a filter which could be connected between the threaded necks of water bottles to thus allow for filtration of water through exhausted Zeolite filters for purifying and sterilization of the water. A device of this type is shown in U.S. Pat. No. 2,167,225 Van Eweyk. These devices are relatively cumbersome and impractical, being insufficient compact for personal use to be carried from one's waste or on a bicycle frame or the like.

A common theme followed by many artisans has been the proposals of water bottles incorporating filters in the dispensing neck or the like on the theory that a user would draw water from the bottle through the filter. It has also been proposed to design the walls of the bottles to flex inwardly under manual pressure to thereby allow for reduction of volume to either drive fluid through the filter or possibly to allow for the recovery of the compressed walls to draw a partial vacuum thus drawing fluid from an unfiltered compartment through a filter or the like. As will be appreciated, neither the partial vacuum created by oral application of suction to the release valve of a sports bottle or partial vacuum applied by recovery of compressed sidewall is sufficient to create any appreciable pressure drop to force any meaningful volume of flow through a filter to remove impurities.

Efforts to improve on these prior devices have led to the proposal that a bellows pump be mounted on top of a bottle having a side straw so that fluid can be pressurized downwardly through a filter into the bottle to thus be available for withdrawal through the side straw. A device of this is shown in U.S. Pat. No. 5,733,448 to Kaura. While satisfactory for producing some filtration, such devices are incapable of taking the normal form of a traditional sports bottle and, furthermore, typically leave the filter exposed to the drinkable fluid whereby the addition of any additives to the drinking water are exposed directly to the filter thus creating a risk of clogging and contamination of the filter thereby reducing the service life.

A device incorporating a filter in the neck of a bottle for filtering as the wall of the bottle is compressed to squeeze the fluid from the bottle is shown in U.S. Pat. No. 6,468,435 to Hughes.

A multi-stage water purification device has been proposed including a lower compartment having a flexible wall which may be compressed and then released to draw a partial vacuum to thus draw unfiltered water downwardly from an overhead compartment through a multi-stage filter to be partially filtered and stored in the lower compartment so that upon subsequent compression of the flexible wall the partially filtered water will be driven upwardly through a one-way valve to pass through a second stage filter to a filtered water compartment ready to be discharged through a pull up valve. Such devices are relatively complicated, expensive to manufacture and rely on atmospheric pressure to control the rate of fluid flow through the first stage filter. A device of this type is shown in U.S. Pat. No. 7,585,409 to Bommi et al.

Until now artisans were faced with the dilemma of selecting between relatively cumbersome self-filtering sports bottles that were inconvenient to use and those to which the use was discouraged from adding additives because of filter clogging problems.

### SUMMARY OF THE INVENTION

The present invention includes a water bottle having first and second sections separated by a intermediate isolation device from which a filter may be suspended to be disposed in the second section for filtering water from the second section to be expelled into the first section for dispensing through a release valve or nipple. The isolation device includes a one-way valve isolating the filtered water from going back into contact with the filter.

### BRIEF DESCRIPTION OF THE DRAWINGS

FIG. 1 is a perspective view of a combination sports bottle and filtering device of the present invention;

FIG. 2 is a view similar to FIG. 1 but depicting sections of the bottle separated from one another;

FIG. 3 is a vertical sectional view, in enlarged scale, taken along the line 3-3 of FIG. 1;

FIG. 4 is a exploded view, in enlarged scale, of the lower portion of the upper section and coupling ring exploded above the lower section;

FIGS. 5, 6, 7 and 8 are transverse sectional view taken along the respective lines 5-5, 6-6, 7-7 and 8-8 of FIG. 3;

FIG. 9 is a vertical sectional view, in enlarged scale, taken along the line 9-9 of FIG. 6;

FIG. 10 is a vertical sectional view similar to FIG. 9 but showing the bottom section decoupled from an isolation and coupling device;

FIG. 11 is a perspective view of a second embodiment of the sports bottle and filter device of the present invention;

FIG. 12 is a perspective view similar to FIG. 11 but exploded;

FIG. 13 and FIG. 14 are transverse directional views, in a large scale, taken along the lines 13-13 and 14-14, respectively, of FIG. 12;

FIG. 15 is a partial vertical sectional view, in a large scale, of the sports bottle and filter device shown in FIG. 11;

FIG. 16 is a transverse sectional view taken along the lines 16-16 of FIG. 15;

FIGS. 17, 18 and 19 are detailed views, in a large scale, taken along the lines 17-17 of FIG. 16;

FIG. 20 and FIG. 21 are transverse sectional views, taken along the lines of 20-20 and 21-21 of FIG. 15, respectively;

FIG. 22 is a partial perspective view, in reduced scale, of the top of the lower bottle section shown in FIG. 12;

FIG. 23 is a transverse sectional view, in an enlarged scale, taken along the lines 23-23 of FIG. 22;

FIG. 24 is a front view, in reduced scale, of the sports bottle shown in FIG. 11 but with the pump extended;

FIG. 25 is a vertical sectional view, in a large scale, taken diametrically through the sports bottle shown in FIG. 24; and

FIG. 26 is a vertical sectional view similar to FIG. 25 showing the pump being retracted.

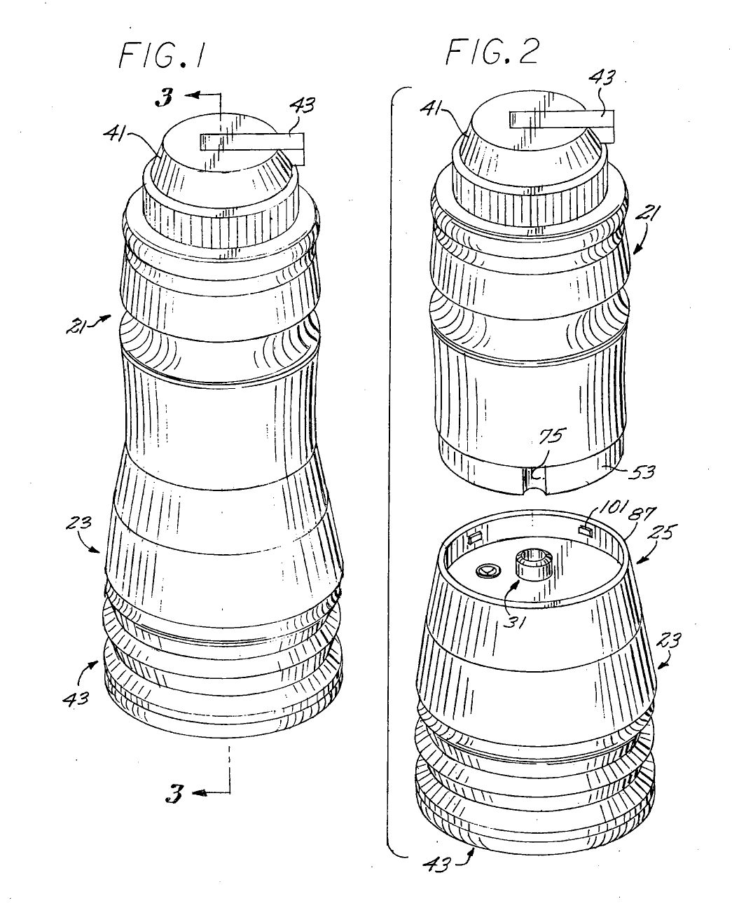

### DETAILED DESCRIPTION OF THE PREFERRED EMBODIMENTS

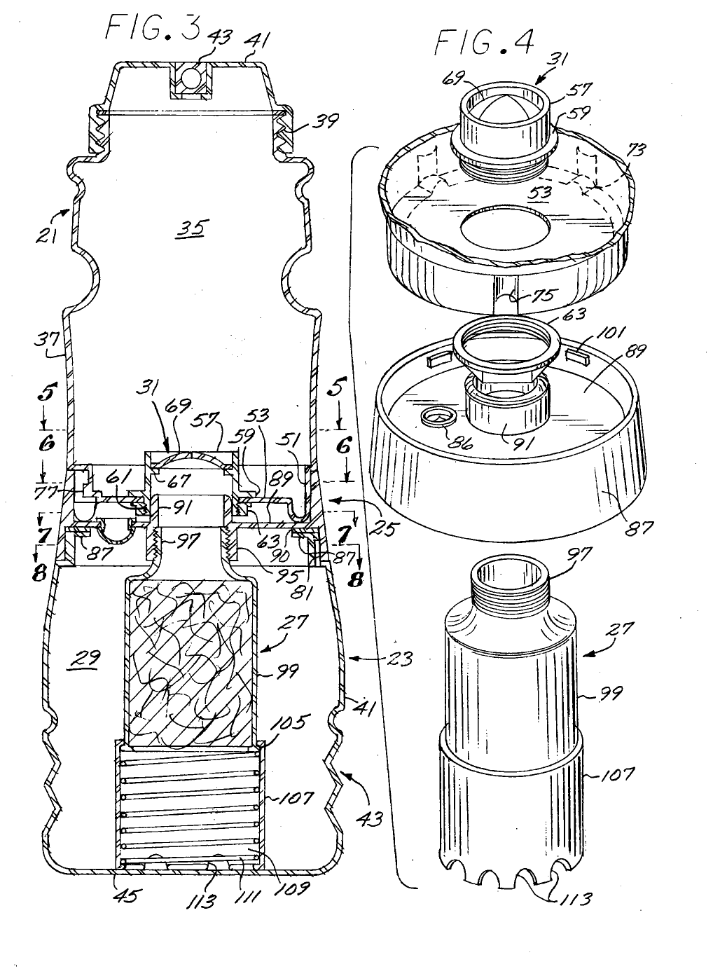

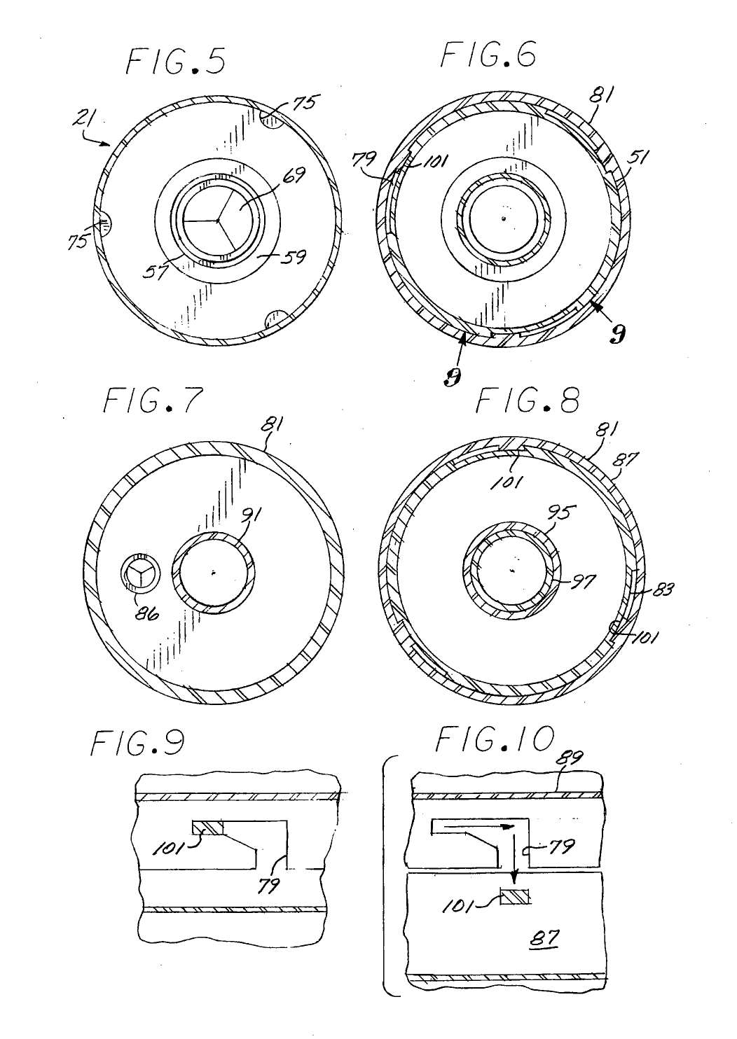

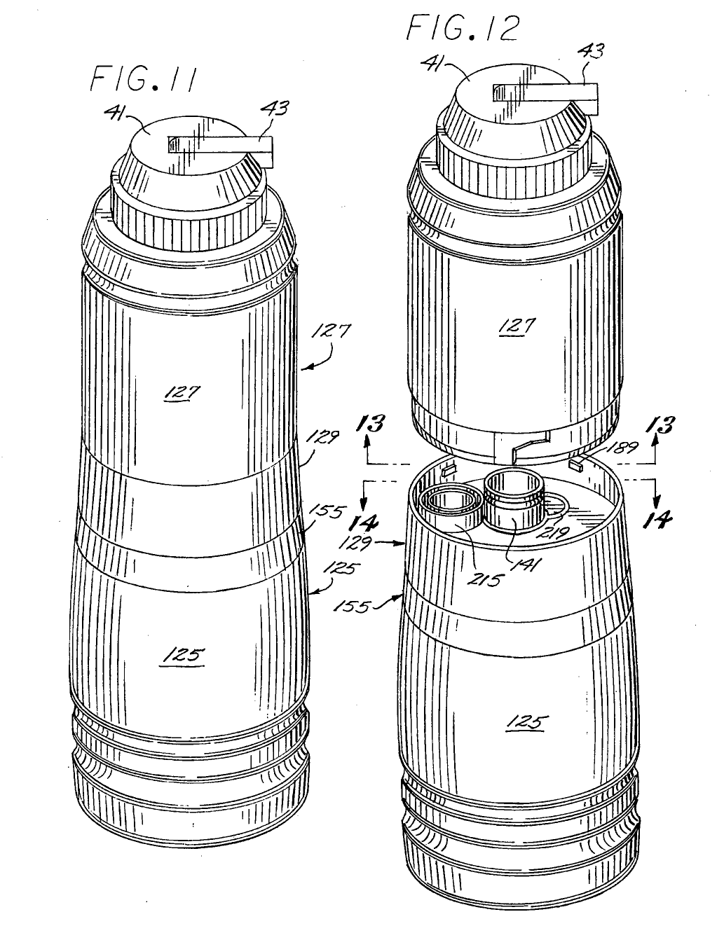

Referring to FIGS. 1 and 3, the personal water bottle and filter device of the present invention includes, generally, an upper bottle section 21 coupled to a lower unfiltered bottle section 23 by means of an isolating and coupling device 25. The isolating and coupling device 25 suspends a filter device 27 in the chamber 29 formed by the bottle section 23 for flow of liquid upwardly there through upon application of pump pressure to flow through a one-way check valve 31 to thus isolate the filtered water from the unfiltered water and from the filter.

Athletes, when exposed to competitive or other strenuous activity are encouraged to consume plentiful quantities of fluid and often prefer to add energy supplements or other additives to the liquid to enhance their performance. Thus, there exists a demand for a personal filtration water bottle device which is efficient to receive tap water and the like for filtration and which might be mixed with different types of additives and readily available for dispensing to hydrate the athlete. It is this objective to which the present invention is directed.

The bottle device of the present invention may be manufactured in separate upper and lower sections, the lower section 23 being configured for receipt of the filter device 27 and to facilitate a pump, while the upper section 21 acts as a storage chamber 35 for storing filtered fluid and the like. The bottle may be manufactured from any one of a number of different plastics such as high density polyethylene, polypropylene, poly vinyl fluoride, polytetrafluroethylene, or any other material well-known to those working in the art.

The upper, unfiltered bottle section 21 includes a sculptured peripheral wall 37 narrowed at its upper extremity to form an externally threaded neck 39 which receives an internally threaded cap 41 having a sealing spout 43 pivotally mounted thereon.

The lower, unfiltered section 23 includes a flexible peripheral wall 41 which may be configured with flexible annular bevels 43 to allow for the bottom wall 45 to be compressed upwardly a selected distance from the position shown in FIG. 3 to reduce the internal volume and act as a pump.

The bottom wall 51 of the upper bottle section 21 is rolled back on itself about the outer periphery to form an annular fold about an annular disk 53 formed centrally with a through bore 55 which receives the lower extremity of a stub tube 57 configured with an upstanding nipple. The stub tube 57 is formed medially with a radially projecting mounting flange 59 and projects downwardly there from through the bore 55 and is externally threaded with threads 61 for receipt of a hex nut 63 to fasten the stub tube in place. The stub tube is formed internally with an annular mounting flange 67 which mounts a duck bill valve 69 for flow of fluid upwardly there through but checking against flow downwardly there through.

The bottom wall is formed about its exterior periphery with downwardly and outwardly opening breather channels 73 and 75 for introducing atmospheric air under the wall to the top of the bottom section 23.

The wall is formed in its exterior periphery with a plurality of circumferentially spaced, radially outwardly opening bayonet style notches 79 to form a screw thread connection with the coupling and isolation device 25.

The upper portion of the bottom bottle section 23 is configured with a reduced in diameter neck 81 which is also formed with radially outwardly opening bayonet style coupling notches 83 spaced about the periphery thereof. The neck is configured at its upper edge with a radially inturned annular sealing ring 88.

The coupling and isolation device 25 includes a cylindrical peripheral skirt 87 circumscribing a medial, annular, horizontal wall 89 which is configured centrally with a vertical boss having at its upper extremity an upstanding nipple 91 sized and configured to be slip fit into sealing engagement with the interior of the bottom extremity of the stub tube 57. The wall 89 is formed centrally on its underside with a tubular boss 95 aligned with the nipple 91 and internally threaded for screwable connection with the exteriorly threaded neck 97 of the pump housing 99 of the filter device 27.

The skirt 87 is configured on its interior with annular teeth 101 spaced about the periphery thereof for selective engagement with the respective bayonet notches 79 and 83.

The filter device 27 is preferably configured with the cylindrical housing 99 incorporating on its lower extremity a radially outturned flange 105 over which is telescoped a tubular pump housing 107 configured interiorly with a pump chamber 109 which receives a coil compression spring 109. The lower extremity of the housing 107 is formed with radially outwardly opening semi-circular apertures 113 forming fluid inlets from the chamber 29.

The filter device 27 includes a media 100 which may take any form for effectively filtering tap water such as that disclosed in U.S. Pat. Nos. 6,468,435 or 7,585,409. In one embodiment I have selected an Ionic Adsorption Micron Filter.

The filter device 27 is configured with a length sufficient to cause the bottom extremity of the pump housing 107 to abut the bottom wall 45 of the bottom bottle section 23 to be reciprocated by compression of the wall 45 upwardly and release to be driven downwardly by the spring 111 to essentially act as a snorkel to draw in a supply of tap water.

As will be appreciated, the pump device may take many different forms and in some embodiments will incorporate a radially inwardly compressible walls for the bottle section 23 and a tubular snorkel extending down from the filter device 27 such that compression of such side walls may be compressed to pressurize the chamber 29 and drive water up through the snorkel and through the filter. In other embodiments, the pump housing 107 is formed at its lower extremity with the apertures sized to have a composite cross sectional flow which will throttle flow radially outwardly there through when the housing is driven rapidly outwardly, to thus raise the pressure in the chamber 109 to drive water in that chamber upwardly through the filter.

Mounted eccentrically in the wall 89 is a one-way breather valve 86 which is in fluid communication with the respective breather channels 73 and 75 for selective introduction of air into the unfiltered liquid chamber 29. In some embodiments, the device of the present invention will incorporate the bleeder orifice in place of the one-way valve 86 to provide for slow bleeding in of atmospheric air but sufficiently small to resist venting when the venting at the same rate the volume chamber 29 is reduced upon compression of the bottom wall 45.

Interposed between the bottom side of the wall 89 and flange 87 is a annular fiber seal ring 90.

It will be appreciated that in some instances, the bottle and filtration device of the present invention may be constructed as a single unit with the bottom bottle section 23 incorporating a side inlet for introduction of tap water.

In operation of the sports bottle of the present invention, an athlete may unscrew the bottom bottle section 23 from the coupling device 25 for tap water to be introduced downwardly through the nipple 91 to flow downwardly through the filter device 27 and out the apertures 113 to fill the lower bottle section 23 with, for instance 20 ounces of water. Once the lower bottle section 23 is filled, the bottle section may be screwed back onto the coupling device 25 to compress the housing flange 87 against the seal 90 to seal the fluid against leakage. In one preferred embodiment, the upper and lower bottle sections 21 and 23 are formed with a volume of about 20 fluid ounces. It will be appreciated that as the lower chamber 29 fills, water will flow radially inwardly through the apertures 113 into the pump chamber 109 and snorkel up into the filter media.

With the bottle device upright, the athlete may then press the bottom wall 45 axially upwardly to collapse the bellows 43 thus reducing the volume of the chamber 29 and currently driving the pump housing 107 upwardly to thereby cooperate with the filter housing to also, in piston-like fashion reduce the volume of the pump chamber 109 thereby cooperating to cooperate in driving a volume of unfiltered water upwardly through the filter and upwardly out the nipple 91 to pass through the one-way valve 69 into the chamber 35. This procedure may be repeated two or three times to totally evacuate the fluid from the chamber 29, it being appreciated that between each pump the return spring 109 will return the bottom wall 45 to its lower most position as shown in FIG. 3 to again draw a volume of atmospheric air in through the valve 86 from the channels 75 and 73 sufficient to displace the liquid that has been displaced upwardly into the upper chamber 35. As will be appreciated by those in the art, the pump effect can be produced by many different pumping arrangements, including a piston pump by itself or other forms of flexible chamber walls which might be compressed to reduce the volume in the chamber 29.

If desirable, the bottle section 23 may again be separated from the section 21 and a new supply of tap water introduced into the lower chamber 29 and the lower bottle section 23 recoupled to the coupling device 25 to thereby provide the athlete with approximately 20 ounces of filtered water in chamber 35 and 20 ounces of unfiltered water in the chamber 29 ready to be pumped through the filter device 27 when the quantity of filtered water has been depleted.

It will be appreciated that the filter device 27 will have long service life, maybe upwards of 1000 filtrations, thus saving the environment from accommodating disposal of some 1000 or so separate sports bottles. When the filter device reaches the end of its service life, with the bottle section 23 separated, the device may be unscrewed from the boss 95 and replaced with a new filter.

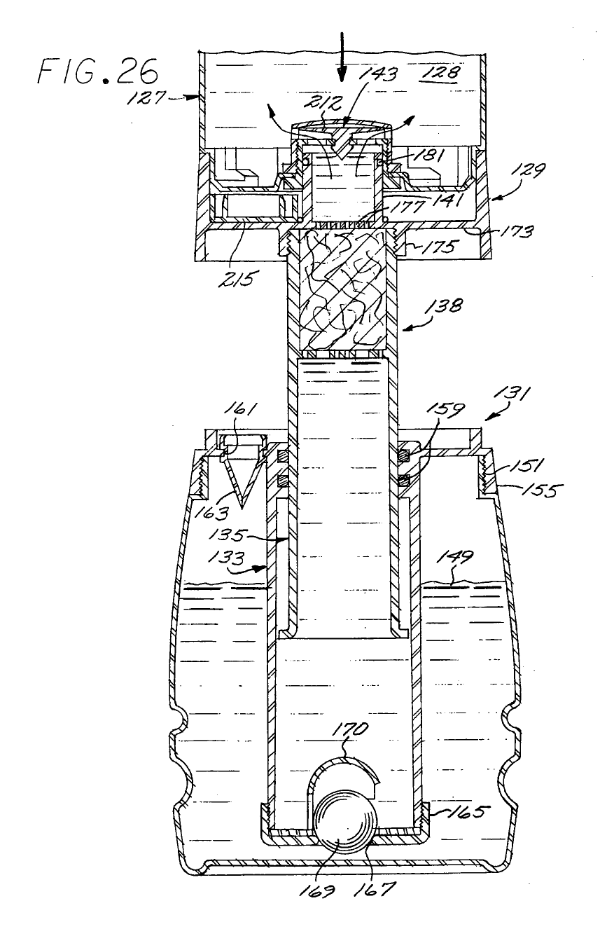

Referring to FIGS. 11, 15 and 25, the sports bottle and filter combination shown in this embodiment is similar to the device shown in FIG. 1 and includes a lower unfiltered bottle section 125 and upper filtered bottle section 127 coupled together by an isolation and coupling device 129. With continued reference to FIGS. 15 and 25, the lower bottled section 125 is formed with a cylindrical plastic body reduced-in-diameter in its upper extremity to removably mount a top cap, generally designated 131. Depending centrally from the top cap 131 is a female cylinder tube defining housing, generally designated at 133, which receives in sliding relation a male piston tube defining a housing 135 carried from the coupling device 129 and which houses at its upper extremity the filter media 137. The tube 135 includes a medical transverse wall 138 formed with through bores 140 for flowing fluid upwardly into the filter media 137. Surmounted on the coupling device 129 is a central upstanding stub tube or pipe 141 that mounts an umbrella style check valve 143 which serves to flow fluid into the upper body section 127 but isolates the filter media 137 from the fluid in the upper bottle section. Thus, the lower fluid chamber 147 formed by the lower bottle section 125 may be filled with fluid 149 and the bottle sections uncoupled from one another. Fluid will from the chamber will flow into the cylinder tube 133. Upon pumping the pump device form the position shown in FIG. 26 to the position shown in FIG. 25, fluid will be driven upwardly in the piston tube 135 to raise the umbrella trip valve poppet and establish flow there past into the chamber 128 formed by the upper bottle section 127. This procedure may be repeated until the upper bottle is filled with filtered water ready for use.

Referring to FIGS. 15, 25, and 26, the bottom bottle section 125 is necked down in its upper extremity and formed with a male screw threads 151 which mate with the female screw threads formed in the annular flange 155 of the upper cap device 131. The cap device 131 is formed centrally with a boss defining a through vertical bore and includes a pair of O-ring glands mounting respective dynamic O-rings 159 for sliding engagement with the exterior wall of the piston tube 135.

The cap device 131 is formed to one side with a though bore 161 which receives a duck bill check valve 163 for venting air into the lower bottle section chamber 147. The cap device 131 is formed on its top side with an annular flange 165 for mating in telescopical relationship with the coupling ring 129.

With continued reference to FIGS. 15 and 25, the cylinder tube 133 is formed at a lower extremity with external male threads for mating with an inverted hat-shaped cap, generally designated 165, which is formed centrally with an orifice 167 against which a ball poppet 169 abuts. A capture cage 170 is mounted on top of the cap 165 to capture the ball poppet 169.

The coupling ring 129 is formed with a peripheral annual skirt 171 which is somewhat conically shaped and is configured with a transverse wall 173 configured centrally with a downwardly projecting internally threaded stub tube 175 into which the upper end of the cylinder tube 133 is threaded. The wall is formed centrally with perforations 177 and is configured on its top side with the upstanding stub tube 141. The stub tube 141 is configured at its upper extremity with an external O-ring gland receiving a dynamic O-ring 181.

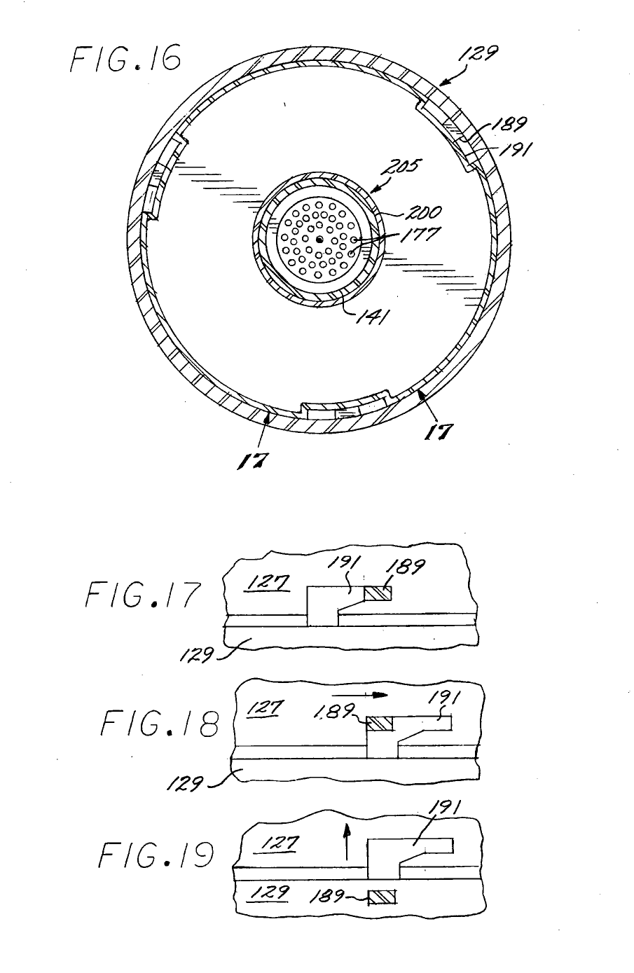

With reference to FIGS. 15 and 16-19, the interior side of the coupling skirt 171 mounts four radially inwardly projecting bayonet teeth 189 spaced equidistant about the interior of the skirt for releasable engagement with the radially outwardly opening bayonet notches 191 formed in the exterior of a reduced in diameter plug 195 at the bottom of the upper bottle section 127. In one embodiment, the skirt at its lower extremity is constructed to releasably fasten to the flange 165 as by an interference fit or by screw or bayonet threads. In that regard, the peripheral wall of the upper bottle section 127 is necked down to form the reduced-in-diameter plug 195 and the bottom wall thereof is formed centrally with a through bore which receives a fitting 201 configured with an exteriorly threaded upstanding neck 203.

Screwed downwardly onto the neck 203 is a tubular barrel of a valve fitting, generally designated 201, which cooperates to trap the marginal edge of the bore 200 against annular the base flange of the fitting 201. The fitting 201 is configured to sealingly receive the upstanding pipe 141 and its O-ring 181. The fitting 201 mounts an orifice plate 207 configured with pluralities of orifices 209 and a central bore 211 which receives the vertical stem 213 of the valve 143 for vertical sliding therein. The valve includes a circular poppet head 199 which, in the closed position shown in FIG. 15, overlies the orifices 209 in umbrella fashion.

Referring to FIGS. 22 and 23, in one preferred embodiment, the cap device 131 includes a pipe cap 215 which includes an anchor ring 217 and tether 219 for being captured to the pipe 141 when the upper and lower bottle sections are separated.

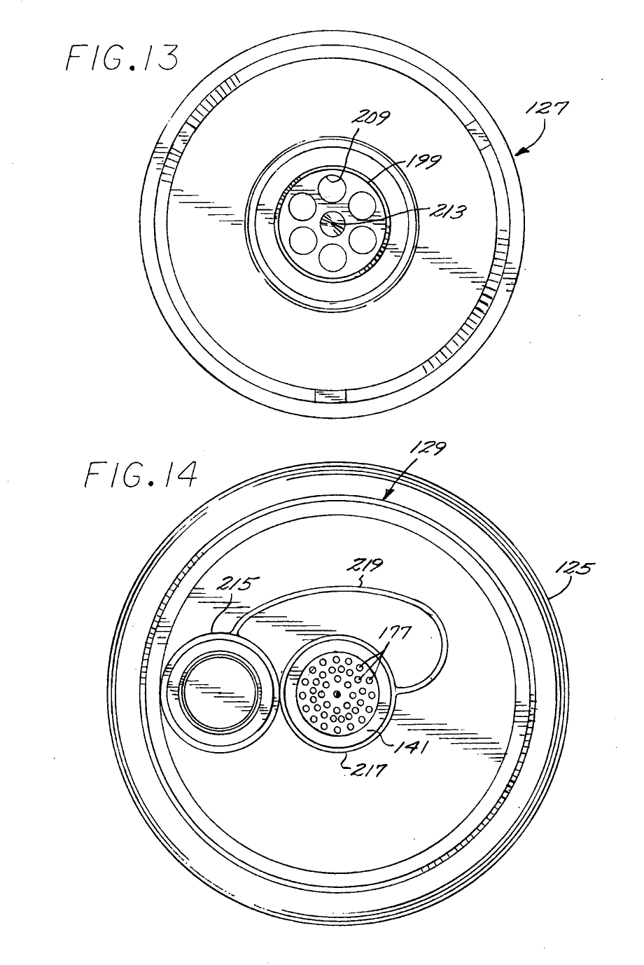

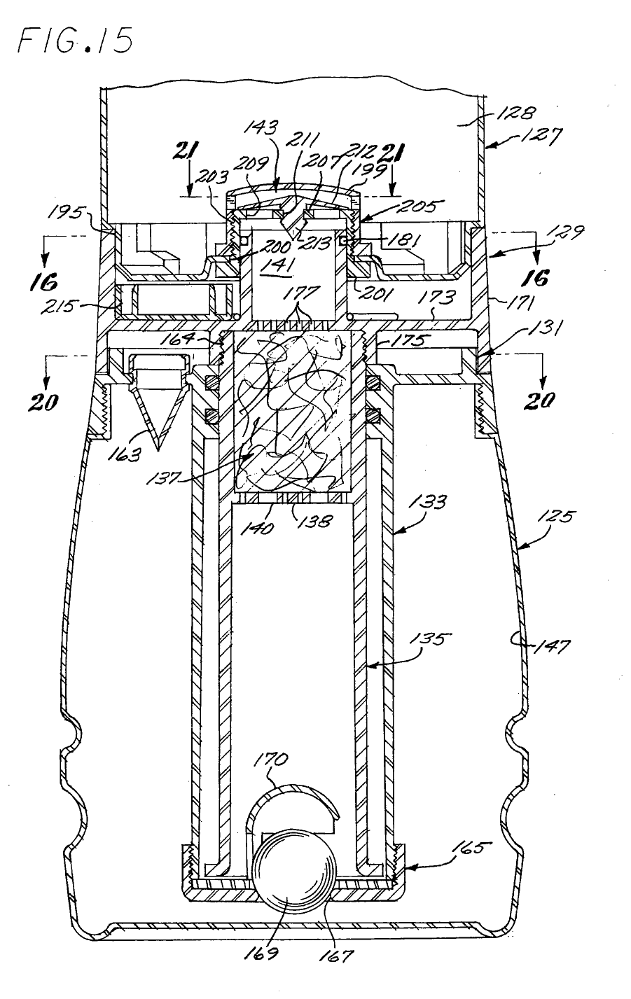

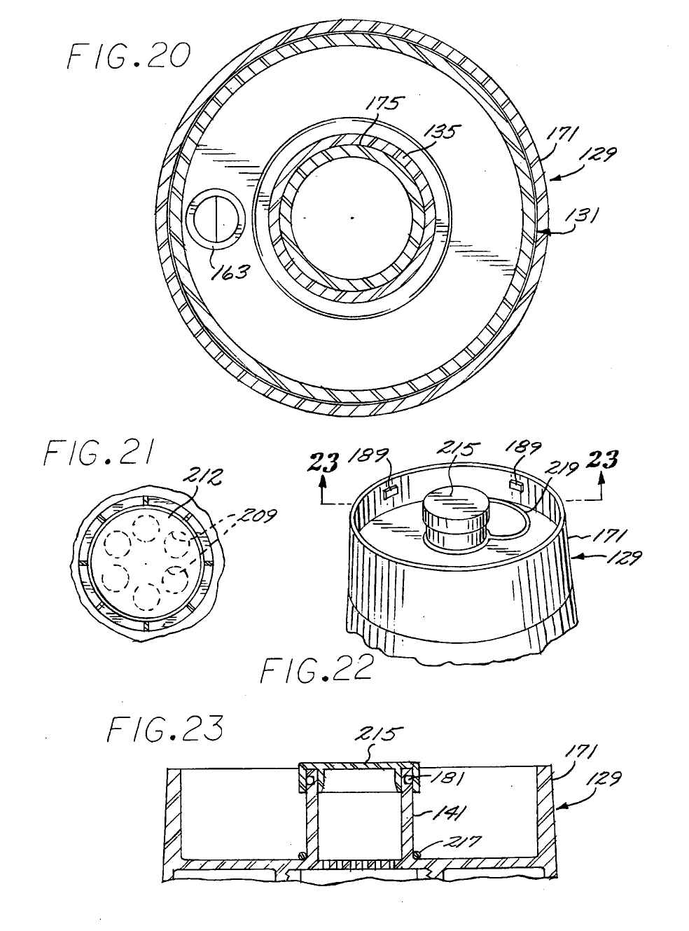

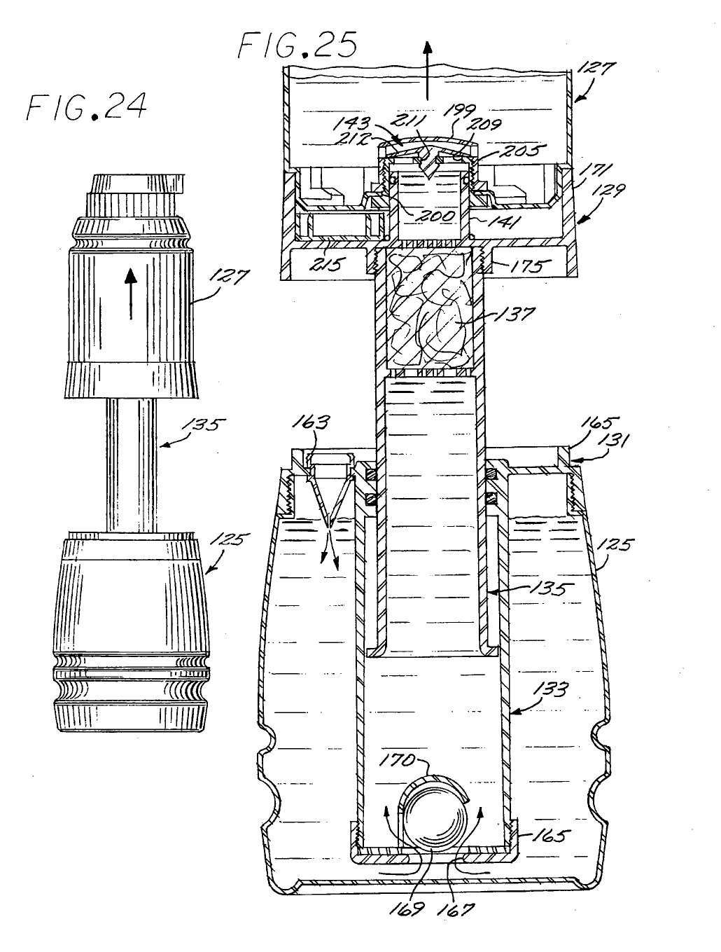

In operation, when it is desirable to fill the bottle above the embodiment of FIGS. 11-26, the user may separate the upper and lower bottle sections and, for instance, unscrew the lower bottle section 125 from the cap assembly 131 and pour water from a spigot into the chamber 147. If desirable, it would also be possible to fill the upper bottle section by removing the top 41 and filing that section for carrying a maximum quantity unfiltered water. In any event, it will be appreciated that the cylinder tube 133 will fill with fluid. When it is desirable to pump unfiltered water through the filter 137, the user may grasp the upper and lower bottle sections to utilize them as hand holds to draw the upper and lower bottle sections apart as shown in FIG. 25 to telescope the piston tube upwardly relative to the cylinder tube and generate a reduced pressure within the tubes 133 and 135 to draw even more unfiltered water 149 through the orifice 167 past the ball poppet 169 up into the extended interior of the combined cylinder and piston tubes 133 and 135 to charge the pump with a volume of unfiltered water. Then, the upper and lower bottled sections may be pressed together as demonstrated by the directional arrow in FIG. 26 to reduce the volume within the pump closing the ball poppet on the orifice 167 thus increasing the hydrodynamic pressure thereof, causing the pressure to flow the fluid through the filter orifices 209 under the umbrella poppet 212 to raise such poppet and allow the water from the pump to flow from the filter media 137 upwardly into the pipe 141 to flow past the valve 143 to flow the full charge of fluid into the chamber 128 of the upper bottle section 127 as the bottle sections return to their closed positions shown in FIG. 15. The upper and lower bottle sections may then again be drawn apart to thus take another charge of fluid into the pump and the process repeated to pump more filtered water upwardly into the upper bottle section 127 until the upper chamber 128 is fully charged with filtered water.

The filtered water is then available in the upper bottle section to be consumed by the user. If desirable, the upper bottle section 127 may be disengaged from the lower bottle section by unscrewing the upper bottle section 127 from the coupling device 129 as the upper bottle section is rotate clockwise relative to the coupling device as viewed in FIG. 16 to thereby disengage the lugs from the respective notches 191 to free the upper bottle section 127. If desirable, the cap 215 may be inserted on the stub pipe 141 as shown in FIG. 23 to seal any unfiltered water within the chamber 147.

As will be appreciated by those skilled in the art, once the filtered water has been consumed, the user may easily refill the lower bottle section 125 from any convenient spigot or public water supply to thus clean an new supply of water for subsequent filtration and consumption.

It will be appreciated that the components of the embodiment of FIGS. 11-26 can be fully disassembled for cleaning and/or even replacement of the filter media 137, or replacement of any malfunctioning components.

It will be further appreciated that the filter and piston tubes may be configured with cross-sectional and longitudinal dimensions to allow for high volumes of fluid to be pumped with each reciprocation of the pump to provide for robust quantities of fluid filtration with each pump. Additionally, the construction allows for application of high magnitudes of pump forces to apply high pressure from the pumps to provide for rapid and convenient filtration in a minimum filtering time.

Additionally, it will be appreciated that the device of the present invention has particular application for baby formulas and the like such that the parent will be able to gather water for mixing with the babies formula directly from a readily available tap thus eliminating the necessity of carrying numerous different bottles when traveling away from home.

From the above it will also be appreciated by those skilled in the art that the combination sports bottle and filter device or the present invention provides a convenient and economical means for storage and filtration of tap water to maintain the filtered water separate from the unfiltered water and serve to isolate the filtered fluid so that additives added to the filtered water will be isolated from the filter to thus prevent clogging of the filter pores.

I claim:

1. Combination sports bottle and filter apparatus comprising:
a bottle having top and bottom walls, the bottom wall including and inlet;
a fluid storage container adjacent the bottom wall and formed with a chamber for storing tap water;
a filter device disposed in the storage container, including an outlet coupled to the inlet, for receiving fluid from the container and flowing it through the outlet into the bottle;
a check valve for restricting fluid flow to flow only from the container into the bottle;
the chamber including a piston pump operable to pump fluid from the chamber, through the filter device, out the outlet and into the bottle.

2. The combination sports bottle and filter apparatus as set forth in claim 1 that includes:
a mounting ring interposed between the container and bottle and mounting the filter device.

3. The combination sports bottle and filter apparatus in claim 1 wherein:
the container includes a bleeder valve for bleeding atmospheric air into the chamber.

4. The combination sports bottle and filter apparatus of claim 1 that includes:
a coupling ring device including an intermediate wall interposed between the container and bottle, and a peripheral skirt surrounding adjacent ends of the container and bottle and removably coupled to the bottle and container.

5. Combination sports bottle and filter apparatus of claim 2 wherein:
the pump includes a cylinder tube carried form the container and a piston tube carried from the ring.

6. A filtering sports bottle device comprising:
a bottle device configured with longitudinally disposed filtered and unfiltered chambers;
the bottle device including a filtered liquid outlet in the filtered chamber;
a filter device disposed in the unfiltered chamber, including a filter inlet and filter outlet;
an isolation device interposed between the chambers, mounted to the outlet of the filter, and including a one way valve for flowing liquid from the filter outlet into the filtered chamber; and
a piston pump device in the unfiltered chamber for pumping fluid from the unfiltered chamber into the filter inlet, through the filter device and out the one way valve.

7. A filtering sports bottle device of claim 6 wherein:
the pump device include a flexible wall in the bottle forming the unfiltered chamber for compression to generate pressure in the unfiltered chamber.

8. A filtering sports bottle device claim 6 wherein:
the pump device includes a piston pump in communication with the inlet to the filter.

9. A filtering sports bottle device claim 7 wherein:
the pump device includes a piston pump connected with the inlet to the filter.

10. A filtering sports bottle device claim 6 wherein:
the bottle device is configured with discrete upper and lower bottle sections forming the respective filtered and unfiltered chambers; and
the isolation device includes a coupling device for removably coupling the upper and lower bottle sections together.

11. A filtering sports bottle device is set forth in claim 6 wherein:
the pump device includes an elongated piston tube moving in one extremity the filter device and formed at the opposite end with an open end the pump device further including a cylinder tube received slidably at one end to the bottle and including at its opposite end a check valve for admitting fluid flow thereto.

12. The filtering sports bottle device of claim 6 wherein:
the isolation device includes a vent valve for introducing air into the unfiltered chamber.

13. Filter sports bottle apparatus comprising:
a bottle device including filtered and unfiltered bottle sections formed with respective filtered and unfiltered chambers;
a passage from the unfiltered to the filtered chambers;
a check valve in the passage for flowing fluid from the unfiltered to the filtered chamber;
a filter device in the unfiltered chamber connected with the passage;
a pump actable to draw fluid from the unfiltered fluid chamber, through the filter device, the check valve and into the filtrated fluid chamber.

14. The filter sports bottle apparatus of claim 13 wherein:
the pump device includes a cylinder tube in the unfiltered fluid chamber and a piston tube for reciprocating in the cylinder tube.

15. The filter sports bottle apparatus of claim 13 wherein:
the bottle includes discrete filtered and unfiltered bottle sections forming the respective filtered and unfiltered chambers;
a releasable coupling for coupling the bottle sections together.

16. The filter sports bottle apparatus of claim 14 that includes:
a check valve for admitting flow of fluid from the unfiltered fluid chamber into the cylinder tube.

17. The filter sports bottle apparatus of claim 15 wherein:
the pump device includes an open top cylinder tube in the unfiltered bottle section and a piston tube connected to the filtered bottle section and received reciprocally in the cylinder tube.

18. The filter sports bottle apparatus of claim 17 that includes:
a check valve for admitting flow from the unfiltered chamber to the cylinder tube.

19. The filter sports bottle apparatus of claim 13 that includes:
a vent valve for venting air into the unfiltered chamber.

20. The filter sports bottle apparatus of claim 15 wherein:
the filtered bottle section includes a bottom wall mounting a disconnect fitting formed with a downwardly opening bore, the fitting being surmounted by the check valve;
the unfiltered bottle section includes a top wall formed with a central fitting mounting the cylinder tube and configured for slideably receiving the piston tube and wherein;
a coupling device includes a transverse wall formed with an upstanding stub pipe to be slip fit into the downwardly opening bore, the coupling device further including on its bottom side a downwardly directed stub tube removeably coupled to the upper extremity of the piston tube, the transverse wall including at least one opening for communication of fluid from the piston tube upwardly into the stub pipe for flow out the check valve.

21. The filter sports bottle apparatus of claim 20 wherein:
the cylinder tube is configured with a bottom extremity formed with male threads; and
the pump device includes a cap threadably screwed to the male threads and including an inlet port, the pump device further including a poppet device cooperative with the inlet port to admit flow into the piston tube but to block flow there from.

22. Combination sports bottle and filter apparatus comprising:
first and second filtered and unfiltered cylindrical bottle sections configured to mate together to form a substantially continuous external vertical profile, configured with respective filtered and unfiltered chambers and being formed with a respective first and second end walls;
a first fitting mounted on the first end wall and formed with a downwardly opening bore;
a check valve mounted on the first fitting for admitting fluid into the filtered but restricting fluid flow there from;
the second end wall formed with an open ended bore;
a coupling device for removably coupling the first and second bottle sections together, the coupling device including a transverse wall interposed between the first and second end walls and including an upstanding pipe section received in sealing relationship with the downwardly opening bore and further including a downwardly depending stub tube;
a piston tube carried from the stub tube, including a filter device and received sealingly in the through bore in the second fitting;
a cylinder tube carried from the second end wall and receiving the piston tube for reciprocation therein, the cylinder and piston tubes being configured so that, when the coupling is operated to disconnect the first and second sections from one another and the bottle sections are reciprocated alternatively away from one another and toward one another, the piston tube will be reciprocated in the cylinder tube to pump fluid from the piston tube through the filter device and stub pipe through the check valve into the filtered bottle section.

23. The combination sports bottle and filter apparatus of claim 22 wherein:
the filtered bottle section is formed in its exterior periphery with bayonet connector slots; and
the coupling device is formed with bayonet lugs for releasably engaging the bayonet slots.

24. The combination sports bottle and filter apparatus of claim 22 includes:
screw thread means connecting the piston tube to the stub tube.

25. Combination sports bottle and filter apparatus comprising:
first and second cylindrical bottle sections of complimentary shape and positioned in end-to-end relationship;
the second bottle section being formed at its upper extremity with a reduced-in-diameter neck, the neck including male threads;
a cap device on the second bottle section including a cylindrical flange formed with female screw threads engaged with the male screw threads, the device further formed with an upstanding annular flange and being formed centrally with a first fitting formed with a through central bore and including annular dynamic sealing means in the bore;
a breather valve mounted in the cap device for venting atmospheric air into the first bottle section;
the first bottle section including a reduced-in-diameter boss confronting the second bottle section and formed in its periphery with bayonet lugs, the first bottle section being further formed with a bottom wall formed with a central bore;
a second fitting mounted in the bore and configured with an upstanding barrel configured with a central bore and formed exteriorly with male screw threads;
a valve assembly including a cylindrical wall formed interiorly with female threads for engaging the male screw threads, the valve further including at least one orifice opening into the first bottle section and a poppet for allowing flow into the first bottle section, but restricting flow there from;
a coupling ring device interposed between the first and second bottle sections and being formed with a cylindrical skirt configured with an upwardly projecting barrel for complementary receipt over the boss and including radially inwardly opening bayonet groves for mating with the bayonet lugs, the coupling device further projecting downwardly and being formed with a tubular segment for complementally fitting over the annular flange, the coupling device further including a transverse wall formed with an upstanding pipe section received slidably in the through central bore and further including a downwardly depending tube removably mounting the piston sleeve, the transverse wall including at least one perforation for flowing fluid from the piston tube into the stub pipe.
